(19) United States
(12) Patent Application Publication
(10) Pub. No.: US 2025/0192137 A1
(43) Pub. Date: Jun. 12, 2025

(54) ENERGY STORAGE DEVICE AND METHOD OF PRODUCTION

(71) Applicant: Beyonder AS, Sandnes (NO)

(72) Inventors: Zaisheng WANG, Stavanger (NO); Gang LI, Hafrsfjord (NO); Vladislav VOLKOV, Hafrsfjord (NO); Rasim BATMAZ, Stavanger (NO); Joachim Sebastian BJØRKLUND, Stavanger (NO); Frederik Thorbjørn HULD, Hommersåk (NO); HanHo LEE, Stavanger (NO)

(73) Assignee: Beyonder AS, Sandnes (NO)

(21) Appl. No.: 18/979,136

(22) Filed: Dec. 12, 2024

(30) Foreign Application Priority Data
Dec. 12, 2023 (NO) 20231336

(51) Int. Cl. H01M 4/04; H01M 4/587; H01M 10/054; H01M 10/0569

(52) U.S. Cl. CPC H01M 4/0447; H01M 4/0435; H01M 4/587; H01M 10/054; H01M 10/0569; H01M 2300/0034

(57) ABSTRACT

A method is for manufacturing an energy storage device, wherein the method includes the steps of providing a pre-sodiated anode having a solid electrolyte interface layer and assembling the energy storage device by combining the pre-sodiated anode together with a lithium ion-containing cathode and a lithium ion-containing electrolyte. The invention further relates to an energy storage device having a cathode including lithium ions, a separator, and a lithium salt-containing electrolyte in a suitable case, wherein the energy storage device further has a pre-sodiated anode.

### CROSS REFERENCE TO RELATED APPLICATION

The present application claims priority to Norwegian Patent Application No. 20231336, filed Dec. 12, 2023, which is hereby incorporated herein by reference in entirety.

### FIELD

The invention relates to a method for manufacturing an energy storage device and to an energy storage device.

### BACKGROUND

An energy storage device is a device that can store energy, for example electrical energy storage devices such as batteries, supercapacitors, and metal-ion capacitors. Energy storage devices generally comprise a plurality of energy storage cells, and each cell comprises a negative electrode that is also referred to as the anode, a positive electrode that is also referred to as the cathode, an electrolyte to allow diffusion of charge carrier ions, and a separator to prevent the electrodes from contacting each other while still allowing diffusion of ions. The anode and cathode typically comprise a layer of active material on each side of a current collector, and each cell may comprise a plurality of anodes and cathodes stacked on top of each other, or alternatively one or a few rolled into a jelly roll. The current collectors of the anodes are typically connected to each other at an anode tab at one side, while the current collectors of the cathodes are connected to each other at a cathode tab, often at the same or opposite end of the energy storage cell than the anode tab.

Metal-ion batteries such as lithium-ion batteries generally have insertion materials with faradaic charge-storage mechanism. During charging, the metal ions will be extracted from the cathode and diffuse through the electrolyte to intercalate or alloy in the anode, while the reverse reaction will occur during discharging. The anode material for metal-ion batteries may for example comprise intercalation materials such as graphite, hard carbon, or soft carbon, but also alloying materials such as silicon. The cathode materials may comprise materials with a high concentration of metal ions and a high electrode potential. Metal-ion batteries are characterized by a high energy density, but a relatively low power density and cyclability.

Supercapacitors have a different charge-storage mechanism, where metal ions and anions from the electrolyte will adsorb onto the surface of each electrode upon charging, respectively, and be released back into the electrolyte upon discharging. Since supercapacitors rely on the non-faradaic charge storage mechanism of surface adsorption, their electrodes generally comprise materials with a large surface area such as activated carbon. Supercapacitors are characterized by a high power density and cyclability, but a relatively low energy density.

Metal-ion capacitors are hybrid energy storage devices which integrate a metal-ion battery anode, for example graphite or hard carbon, and a supercapacitor cathode, typically activated carbon, together. Therefore, they exhibit a high specific power, a good cyclic stability, and a moderate specific energy, so they have a wide range of potential applications. However, since neither the anode nor the cathode contains inherent metal ions, it is necessary to pre-dope the metal-ion capacitor with metal ions as charge carriers to run it properly. Metal-ion pre-doping may also lower the electrode potential of the anode to further increase the energy density.

Taking a lithium-ion capacitor as an example, pre-doping of the anode with lithium ions (also referred to as pre-lithiation) is performed to lower the potential of the anode, thereby widening the operation voltage window and increasing the specific energy of the device.

Pre-doping of batteries may also be advantageous to provide the cell with additional metal ions to make up for the ions consumed due to side reactions during the lifetime of the cell, particularly during formation of the solid-electrolyte interface (SEI) in the first cycle. This irreversible SEI formation consumes a large part of the available ions, which lowers the remaining capacity of the cell. For example, when charging a hard carbon anode with lithium ions, the initial coulombic efficiency (ICE) may be around 70-75%, indicating that up to 30% of the initially available lithium ions are consumed in the first charge and will thereby not function as charge carriers in the subsequent cycles. Additionally, lithium is expensive, so it is not very cost-efficient with such a large loss of lithium ions.

### SUMMARY

The invention has for its object to remedy or to reduce at least one of the drawbacks of the prior art, or at least provide a useful alternative to prior art. The object is achieved through features, which are specified in the description below and in the claims that follow. The invention is defined by the independent patent claims, while the dependent claims define advantageous embodiments of the invention.

In a first aspect, the invention relates more specifically to a method for manufacturing an energy storage device, wherein the method comprises the steps of providing a pre-sodiated anode comprising a solid electrolyte interface layer, and assembling the energy storage device by combining the pre-sodiated anode together with a lithium ion-containing cathode and a lithium ion-containing electrolyte.

The energy storage device is a lithium-ion battery cell since a lithium ion-containing cathode and a lithium ion-containing electrolyte is used. The lithium ion-containing cathode may for example be LFP, LCO, NMC, or LNMO. However, by using a pre-sodiated anode which already contains a SEI layer, the ICE of the cell may be significantly increased. This may have the effects that the energy density and lifetime of the cell are increased since less lithium ions are irreversibly lost during the first charge and the cell thereby contains more active lithium ions as charge carriers. By using a pre-sodiated anode, the resulting energy storage device may be less expensive than if a pre-lithiated anode were used, since lithium metal is typically more expensive than sodium metal. Any cost saving on the manufacturing of energy storage devices is extremely important as the amount of energy storage devices produced worldwide is rapidly increasing to help in the electrification of society. Additionally, sodium is more abundant than lithium, and large-scale production of materials containing sodium ions may have less environmental impact than of materials containing lithium ions.

In one embodiment, the step of providing a pre-sodiated anode may comprise charging an anode toward a pre-sodiation electrode comprising sodium metal or a compound containing sodium ions. The anode may typically be a fresh anode, or at least an anode which has not been pre-doped with metal ions or exposed to a charging and/or discharging step. An advantage of this pre-sodiation method is that the degree of pre-sodiation may be precisely controlled through the potential of the anode, thereby optimizing the SEI layer.

The pre-sodiation electrode may additionally comprise lithium metal or a compound containing lithium ions. An advantage of using both sodium ions and lithium ions during the pre-doping step may be that the different properties of the ions, e.g. ionic size, and the side reaction between lithium/sodium and electrolyte can influence the physical and chemical properties of the SEI layers and then impact the battery performance. 1o In one embodiment, the step of providing a pre-sodiated anode may comprise chemically pre-sodiating an anode by immersing at least a portion of the anode in a solution containing a molecular sodium complex with a redox potential below the potential at which a solid-electrolyte interface forms. Due to the low redox potential of the sodium complex, sodium ions will move from the solution to pre-sodiate the anode. The degree of pre-sodiation may be tuned by the redox potential of the sodium complex and the period in which the anode is in contact with the solution. An advantage of this pre-sodiation method is that it may be very cost-efficient and scalable and thereby beneficial for pre-sodiation at industrial scale.

In one embodiment, the step of providing a pre-sodiated anode may comprise the step of applying a layer of sodium metal in direct contact with at least a portion of an anode surface and an electrolyte and pressing the sodium metal layer onto the anode. An advantage of this pre-sodiation method is that the degree of pre-sodiation may be tuned by the amount of sodium metal used relative to the amount of anode active material.

The method may additionally comprise the step of discharging the pre-sodiated anode before the step of assembling the energy storage device. In this way the active sodium ions are released from the pre-sodiated anode before cell assembly so only the sodium ions in the SEI layer remain in the anode. The subsequent energy storage device may therefore behave as a pure LiB.

In one embodiment, the electrolyte may comprise fluorinated ethylene carbonate, which may improve the SEI layer whereby fewer lithium ions may be lost after assembly of the energy storage device. Alternatively, or additionally, the electrolyte may comprise vinylene carbonate which may also improve the SEI layer.

In a second aspect, the invention relates to an energy storage device comprising a cathode comprising lithium ions, a separator, and a lithium salt-containing electrolyte in a suitable case, wherein the energy storage device further comprises a pre-sodiated anode. The energy storage device may for example be a pouch, prismatic, or cylindrical cell. By including a pre-sodiated anode in the energy storage device, less lithium ions will be lost during the first charge since the pre-sodiated anode already contains a SEI layer. The energy density and cycle life of the energy storage device may therefore be improved. 1o In one embodiment, the pre-sodiated anode may comprise hard carbon. Hard carbon has a very low ICE, meaning that many ions are normally consumed when a hard carbon anode is charged for the first time. Therefore, using a pre-sodiated hard carbon anode may be particularly beneficial, since the pre-sodiated anode will result in a much smaller loss of active lithium ions upon first charge of the energy storage device. An energy storage device comprising pre-sodiated hard carbon anode may therefore still possess a high energy density while also exploiting the high power capability of the hard carbon anode.

In the following is described examples of preferred embodiments:

Example 1: Lithium iron phosphate (LiFePO₄) electrodes were manufactured using an industrial-scale slot-die coating process. Commercially available LiFePO₄ material (Type 2, purchased from BTR, China) was coated onto aluminum foil. Similarly, hard carbon electrodes were produced using commercially available hard carbon material (Type 2, purchased from Kuranode, Japan), coated onto copper foil. To enhance the adhesion of the active material coating layer to the metal foil and improve electrode density, a cold calendaring process was employed. The anode underwent a pre-doping process using an electrochemical method, as described in patent application no. PCT/NO2020/050297, wherein the anode was pre-doped with sodium ions by using sodium cathode materials. The pre-doping degree was 10% based on the anode capacity. Pouch-type lithium-ion batteries were assembled following an industrial standard process wherein pre-doped anodes were stacked alternately with cathodes.

Example 2: Lithium iron phosphate and hard carbon electrodes were manufactured in the same way as example 1, but pre-doping of the anode was performed using sodium cathode materials. The pre-doping degree was 15% based on the anode capacity. Pouch-type lithium-ion batteries were assembled following an industrial standard process wherein pre-doped anodes were stacked alternately with cathodes.

Example 3: Lithium iron phosphate electrode was manufactured through an industrial scale slot-die coating process from commercially available lithium iron phosphate (T2™ purchased from BTR, China) on to perforated Al foil. Soft carbon electrode was produced in the same way as example e. The pre-doping degree was 20% based on the anode capacity. Pouch-type lithium-ion batteries were assembled following an industrial standard process wherein pre-doped anodes were stacked alternately with cathodes.

Example 4: Lithium iron phosphate electrode was manufactured through an industrial scale slot-die coating process from commercially available lithium iron phosphate (T2™ purchased from BTR, China) on to perforated Al foil. Hard carbon electrode was produced in the same way as example 1. The pre-doped electrode was produced by mixing sodium cathode (80%) and lithium cathode materials (20%). The pre-doping degree was 15% based on the anode capacity. Pouch-type lithium-ion batteries were assembled following an industrial standard process wherein pre-doped anodes were stacked alternately with cathodes.

Example 5: Lithium iron phosphate electrode was manufactured through an industrial scale slot-die coating process from commercially available lithium iron phosphate (T2™ purchased from BTR, China) on to perforated Al foil. Hard carbon electrode was produced in the same way as example 1. The pre-doped electrode was produced by mixing sodium cathode (50%) and lithium cathode materials (50%). The pre-doping degree was 20% based on the anode capacity. Pouch-type lithium-ion batteries were assembled following an industrial standard process wherein pre-doped anodes were stacked alternately with cathodes.

Example 6: Lithium iron phosphate electrode was manufactured through an industrial scale slot-die coating process from commercially available lithium iron phosphate (T2™ purchased from BTR, China) on to perforated Al foil. Soft carbon electrode was produced in the same way as example 1. The pre-doped electrode was produced by mixing sodium cathode (30%) and lithium cathode materials (70%). The pre-doping degree was 15% based on the anode capacity. Pouch-type lithium-ion batteries were assembled following an industrial standard process wherein pre-doped anodes were stacked alternately with cathodes.

Example 7: Lithium nickel-cobalt-manganate (LNCM) electrode was manufactured through an industrial scale slot-die coating process from commercially available Lithium nickel cobalt manganese (S7LC purchased from RONGBAY TECHNOLOGY, China) on to perforated Al foil. Soft carbon electrode was produced in the same way as example 1. The pre-doped electrode was produced by mixing sodium cathode (30%) and lithium cathode materials (70%). The pre-doping degree was 15% based on the anode capacity. Pouch-type lithium-ion batteries were assembled following an industrial standard process wherein pre-doped anodes were stacked alternately with cathodes.

Example 8: Lithium cobalt oxide (LCO) electrode was manufactured through an industrial scale slot-die coating process from commercially available LCO (983A purchased from PULEAD Technology, China) on to perforated Al foil. Hard carbon electrode was produced in the same way as example 1. The pre-conditioned electrode was produced by mixing sodium cathode (30%) and lithium cathode materials (70%). The pre-doping degree was 15% based on the anode capacity. Pouch-type lithium-ion batteries were assembled following an industrial standard process wherein pre-doped anodes were stacked alternately with cathodes.

### BRIEF DESCRIPTION OF THE DRAWINGS

FIG. 1 shows the measured initial coulombic efficiency for a reference anode and for an anode prepare by means of a method according to the present invention.

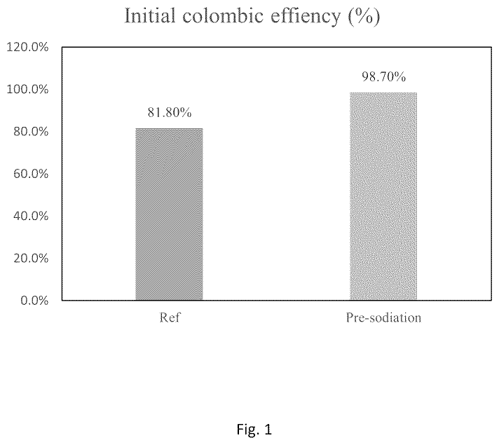

### DETAILED DESCRIPTION OF THE DRAWINGS

### For the Measurements of Initial Columbic Efficiency, the Following Experiment was Carried Out:

Hard Carbon (HC) anodes were prepared via wet film coating/doctor blading technique. A 2.3% solution of styrol-butadiene-rubber (SBR)-100-binder (HIGASHI-SHINBASHI) in water (60 mg) was combined with deionized water (3.5 mL), Hard carbon (Kuraray Battery Materials Japan Co. Ltd., 99%; 3768 mg, 314 mmol), and carbon black (IMERYS, C-NERGY SUPER C65; 80 mg, 6.67 mmol) in a 50 mL grinding beaker. The mixture was milled for 10 min in a vibration mill MM400 from Retsch GmbH. The generated slurry was then casted onto a carbon-primer-coated aluminum foil (Pi-Kem) with a doctor blade (300 μm wet film thickness) and dried overnight. The circular electrodes with 16 mm diameter were punched out and were further dried for 12 h at 80° C. under vacuum before inserting into the glove box.

### Cell Assembly and Electrochemical Measurements:

All cells were assembled using CR2016-casings (MTI Corp.). For the pre-treatment of the anode electrodes, a pre-sodiation cell setup was used as described in Pampel et al [1]. A sodium metal electrode was (freshly) prepared by scratching off the oxide layer of calendared sodium from both sides of the sheet and pressing it onto a steel spacer with a thickness of 1000 μm (d=16.7 mm). The HC anode was placed in the bottom part of the coin cell casing and electrolyte (30 μL) was added consisting of 1 m sodium Hexafluorophosphate (NaPF₆, 99.9%) in a solvent mixture consisting of ethylene carbonate (EC, Alfa Aesar, 99%) and DEC (Sigma Aldrich, 99%) in a volume ratio of 3:7, and 3 vol % of FEC (Alfa Aesar, 98%) were additionally added. Further, a polyethylene separator (thickness: 12 μm, d=19 mm) and the prepared sodium metal electrode adhered to the spacer were placed on top, and the cell was crimped with a pressure of 500 psi. The cells were discharged with an electric current of 0.2 mA cm⁻² and capacity 1 mAh. Thereafter, the cell was disassembled, the excess electrolyte was gently removed from the HC anode with Kimtech precision wipes, and the electrode was washed in full cell electrolyte for 5 min. The cathode was prepared by mixing the active material, super P carbon black, and poly (vinyl difluoride) (PVDF, Aldrich) binder at a weight ratio of 95:2:3 on aluminium. Then cathode was dried at 80° C. in a vacuum for 10 hours. The loading mass of the cathode was 3-4 mg cm⁻². All the electrode preparation procedures were performed under low air humidity (dew point temperature <−70° C.) to avoid Na⁺ extraction from the layered structure. The pre-sodiated Hard carbon was used as the counter electrode and porous glass fiber (GF/D) was used as the separator. The discharge and charge measurements were carried out using a Neware system over a voltage range 2.0-4.0V at 0.05 C rate at 25° C.

As can be seen from the Figure, the ICE of the pre-sodiated anode prepared as explained above was demonstrated to be 98.70%, which is significantly higher than that of the reference anode at 81.80%.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.
[1]J. Pampel, S. Dörfler, H. Althues, S. Kaskel, Energy Storage Mater. 2019, 21, 41.

1. A method for manufacturing an energy storage device, wherein the method comprises the steps of:
a. providing a pre-sodiated anode comprising a solid electrolyte interface layer, and
b. assembling the energy storage device by combining the pre-sodiated anode together with a lithium ion-containing cathode and a lithium ion-containing electrolyte.

2. The method according to claim 1, wherein the step of providing a pre-sodiated anode comprises charging an anode toward a pre-sodiation electrode comprising sodium metal or a compound containing sodium ions.

3. The method according to claim 2, wherein the pre-sodiation electrode additionally comprises lithium metal or a compound containing lithium ions.

4. The method according to claim 1, wherein the step of providing a pre-sodiated anode comprises chemically pre-sodiating an anode by immersing at least a portion of the anode in a solution containing a molecular sodium complex with a redox potential below the potential at which a solid-electrolyte interface forms.

5. The method according to claim 1, wherein the step of providing a pre-sodiated anode comprises the step of applying a layer of sodium metal in direct contact with at least a portion of an anode surface and an electrolyte and pressing the sodium metal layer onto the anode.

6. The method according claim 1, wherein the method additionally comprises the step of discharging the pre-sodiated anode before the step of assembling the energy storage device.

7. The method according to claim 1, wherein the electrolyte comprises fluorinated ethylene carbonate.

8. The method according to claim 1, wherein the electrolyte comprises vinylene carbonate.

9. An energy storage device comprising a cathode comprising lithium ions, a separator, and a lithium salt-containing electrolyte in a suitable case, wherein the energy storage device further comprises a pre-sodiated anode.

10. The energy storage device according to claim 9, wherein the pre-sodiated anode comprises hard carbon.
